(19) United States
(12) Patent Application Publication
(10) Pub. No.: US 2006/0221605 A1
(43) Pub. Date: Oct. 5, 2006

(54) Dive accessory

(75) Inventor: Trevor Theriault, Leamington (CA)

Correspondence Address: ANISSIMOFF & ASSOCIATES;RICHMOND NORTH OFFICE CENTRE, SUITE 201, 235 NORTH CENTRE RD., LONDON, ON, N5X 4E7, CA

(73) Assignee: TREVAD INNOVATIONS INC.

(21) Appl. No.: 11/097,343

(22) Filed: Apr. 4, 2005

(51) Int. Cl. F21L 4/04

(52) U.S. Cl. 362/205; 362/253; 362/86; 362/158

(57) ABSTRACT

A dive accessory has an outer shell encompassing a light maker and a noise maker. The light maker is waterproofed and has a light source electrically connected to an electrical power source for powering the light source. A light switch selectively opens and closes the electrical connection to switch the light source on and off. The noise maker has a hollow chamber having a solid object therein. The solid object is movable within the hollow chamber to produce a noise when the solid object strikes a wall of the hollow chamber. The solid objects may be selectively restrained from moving to prevent the solid object from making noise, and may be selectively permitted to move to permit the solid object to make noise. Combining a light maker and a noise maker into a unitized accessory in this manner provides a more effective and easy to use dive accessory.

### FIELD OF THE INVENTION

The present invention is related to dive accessories for underwater diving. More particularly, the present invention is related to a combination dive light and noise maker for signaling other divers.

### BACKGROUND OF THE INVENTION

Diving flashlights are known in the art, for example U.S. Pat. Nos. 6,547,414, 4,114,187, 4,531,178 and 4,870,550. Underwater audible signaling devices based on the principle of hard objects rattling in a chamber are also known in the art, for example, U.S. Pat. Nos. 5,187,691, 5,652,734 and 5,450,810. It is also known to strap a light stick to an audible signaling device, for example U.S. Pat. No. 6,690,619. It is also known to combine a flashlight and an electronic audible alarm into a night stick, for example U.S. Pat. No. 2,908,901. All of these kinds of devices fulfill certain needs, however, they all have limited versatility for underwater divers. There remains a need in the art for a dive accessory that combines the functions of a variety of tools into a single integrated unit that is convenient and easy to use, versatile and robust.

### SUMMARY OF THE INVENTION

In accordance with the present invention, there is provided a dive accessory comprising an outer shell encompassing a light maker and a noise maker, the light maker being waterproofed and comprising a light source electrically connected to an electrical power source for powering the light source, and a light switch for selectively opening and closing the electrical connection between the light source and the electrical power source to switch the light source between an on state and an off state, the noise maker comprising a hollow chamber having a solid object therein, the solid object movable within the hollow chamber to produce a noise when the solid object strikes a wall of the hollow chamber, the noise maker further comprising means for selectively restraining movement of the solid object to prevent the solid object from making noise and further comprising means for selectively permitting movement of the solid object to permit the solid object to make noise.

The outer shell encompasses both the light maker and the noise maker thereby providing a unitized, structurally integrated device that is durable, portable and aesthetically attractive. Preferably, the outer shell is waterproofed to prevent water from damaging the parts, particularly the electrical parts of the light maker. In one embodiment, the outer shell entirely encloses both the light maker and the noise maker.

The outer shell may comprise any suitable material for the construction of dive accessories, for example, metal, plastic, elastomers, rubber, etc. Materials that are lightweight, strong, corrosion resistant, or a combination thereof are preferred, for example, aircraft grade aluminum and shock resistant plastic. Transparent shock resistant plastic is particularly preferred in front of the light maker in order to permit illumination in front of the dive accessory. Rubber or elastomers are preferred for use in making watertight seals (e.g. membrane seals, O-rings, etc.) around switches and joints.

The outer shell has an internal cavity that may be sub-divided into individual compartments. One compartment may be the hollow chamber of the noise maker. Another compartment may contain the electrical power source. Yet another compartment may hold the light source and any mirrors for focusing and/or directing a light beam. The compartment for holding the light source may swivel for directing the light beam in various directions, and/or may be provided with a facility for creating focussed, normal or wide-angle beams. The compartment for holding the light source may also be provided with rubberized or non-rubberized molded finger grips to assist divers wearing gloves. Still yet other compartments may be included for holding other components of the accessory or for storing various other items. Compartments may be openable to permit access to their interiors.

The light maker comprises a light source, an electrical power source for powering the light source and a light switch for switching the light source on and off. The light maker may also comprise any other standard dive light components. The light source may be any suitable light-emitting element, for example, tungsten filament bulbs, halogen bulbs, light emitting diodes (LED), etc. LEDs are particularly preferred for their durability. The light maker may comprise more than one light source powered by the same power source or different power sources. The power source is preferably a battery or batteries, although other power sources such as shipboard and portable generators may be used. There may be one or more light switches to control intensity of illumination. In addition to switching the light source on and off, the light switch or switches may dim or intensify the illumination. Components of the light maker are located in waterproofed compartments to prevent water damage.

The noise maker is based on the principle of a solid object striking a wall within a hollow chamber. Such noise makers are referred to as clackers. The noise maker in the present invention comprises a hollow chamber having a solid object therein. The solid object is movable within the hollow chamber to produce a noise when the solid object strikes a wall of the hollow chamber. When a diver shakes the dive accessory, the noise made by the solid object striking the wall of the hollow chamber will carry though the water alerting other divers. Since water is a denser medium than air, sound travels better in water. Such a noise maker is particularly effective for communicating with other divers, particularly in low visibility conditions. Furthermore, since it is unnecessary for a diver to bang an object (e.g. a dive knife) against his tanks, and it is unnecessary to tap other divers on the shoulder, a measure of safety is also afforded.

The hollow chamber may be of any suitable size and shape. Preferably, the hollow chamber is substantially cylindrical. The hollow chamber, while encompassed by the outer shell, can be open to the water provided the chamber is waterproofed to prevent water from entering other compartments of the dive accessory and provided that the solid objects cannot escape from the hollow chamber. Preferably, the hollow chamber is enclosed by the outer shell so that water may not enter into the hollow chamber.

The solid object may be any suitable size and shape provided the solid object is movable within the hollow chamber. The solid object may comprise any suitably solid and dense material, preferably a material that does not corrode. More preferably, the solid object comprises a metal (e.g. stainless steel), a ceramic, or a dense plastic or plastic composite. Stainless steel is particularly preferred. Preferably the solid object is spherical or cylindrical. In one embodiment, the solid object is cylindrical having a diameter slightly less than the diameter of the hollow chamber and a length sufficiently less than the length of the hollow chamber so that the cylindrical object can generate sufficient motion to make sufficient noise when it strikes an end wall of the hollow chamber. In another embodiment, the solid object is spherical and has a diameter slightly less than the diameter of the hollow chamber so that the spherical object can roll within the hollow chamber. There may be any number of solid objects within the hollow chamber. When a cylindrical solid object is used, there is preferably one solid object. When a spherical solid object is used, there is preferably more than one solid object.

The noise maker comprises means for selectively restraining movement of the solid object to prevent the solid object from making noise and further comprises means for selectively permitting movement of the solid object to permit the solid object to make noise. Such features dramatically increase the desirability of the dive accessory as the ability to selectively turn on and off the noise generating capacity greatly enhances the versatility, convenience and safety of the noise maker.

The means for selectively restraining movement of the solid object and the means for selectively permitting movement of the solid object may be the same or different means. Thus, one means may control both on and off, or, on may be controlled by one means and off controlled by another means. Such means may be embodied in, for example, bayonet linkages between parts of the outer shell, switches such as slide switches, depression switches, toggle switches, rocker switches and the like, or any other arrangement of parts that result in restraining and/or permitting movement of the solid object.

Whether one means controls both on and off, or one means controls on and another means controls off, there may be a common element involved in controlling the noise maker, for example an element that decreases or increases the length of the hollow chamber (e.g. a movable wall within the hollow chamber). In such an example, selective activation of the means for restricting movement would result in a decrease of the length of the hollow chamber while selective activation of the means for permitting movement would result in an increase in the length of the hollow chamber.

In one aspect, the hollow chamber may comprise a movable end, the movable end movable between a retracted position for restraining movement of the solid object and an extended position for permitting movement of the solid object. The dive accessory may further comprise a biasing means (e.g. a spring) for biasing the movable end toward the extended position.

The means for selectively permitting movement of the solid object may comprise an armature having means for engaging the movable end to hold the movable end in the retracted position and means for disengaging the armature from the movable end to permit the movable end to move to the extended position to permit movement of the solid object. The means for selectively permitting movement of the solid object may further comprise means for biasing the armature into a position for engagement with the movable end. The armature may have a first portion, a second portion and a pivot point between the first portion and the second portion. The means for engaging the movable end may be on the first portion, the means for disengaging the armature from the movable end may be on the second portion, and the means for biasing the armature may comprise a biasing element (e.g. a torsion spring) at the pivot point. Activation of the means for disengaging the armature may cause the armature to pivot at the pivot point thereby disengaging the armature from the movable end. Deactivation of the means for disengaging the armature permits the biasing element to bias the armature into the position for engagement with the movable end.

The means for selectively restraining movement of the solid object may comprise an element (e.g. a piston) connected to the movable end, whereby depression of the element causes the movable end to move to the retracted position to restrain movement of the solid object. The movable end in the retracted position may then engage the means for selectively permitting movement in order to prevent movement of the movable end to the extended position until and unless the means for selectively permitting movement of the solid object is activated.

The dive accessory of the present invention may further include one or more dive utility items, for example, attachment rings, tether lines (e.g. retractable or non-retractable), measuring devices (e.g. rulers, depth gauges, lobster gauges, clocks, stop watches, etc.), whistles, audible electronic alarms, dive computers, GPS, locator chips, utility knives, line cutters, etc. Dive utility items may be attached to or integrated with the dive accessory. Dive utilities, for example rulers and gauges, may be luminescent or phosphorescent for greater visibility.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1A is a schematic cross-sectional side view of a first embodiment of a dive accessory of the present invention with a clacker in an off-position;

FIG. 1B is a schematic cross-sectional side view of the dive accessory of FIG. 1A with the clacker in an on-position;

FIG. 1C is a schematic top view of the dive accessory of FIG. 1B;

FIG. 1D is an end view of a switch depicted in FIGS. 1A-1C;

FIG. 2A is a schematic cross-sectional top view of a second embodiment of a dive accessory of the present invention with a clacker in an off-position;

FIG. 2B is a schematic cross-sectional side view of the dive accessory of FIG. 2A;

FIG. 3A is an enlarged view of the clacker depicted in FIG. 2A;

FIG. 3B shows the clacker of FIG. 3A in an on-position;

FIG. 4A is a schematic cross-sectional top view of a third embodiment of a dive accessory of the present invention with a clacker in an off-position;

FIG. 4B is a schematic cross-sectional side view of the dive accessory of FIG. 4A;

FIG. 5A is an enlarged view of the clacker depicted in FIG. 4A; and,

FIG. 5B shows the clacker of FIG. 5A in an on-position;

### DESCRIPTION OF PREFERRED EMBODIMENTS

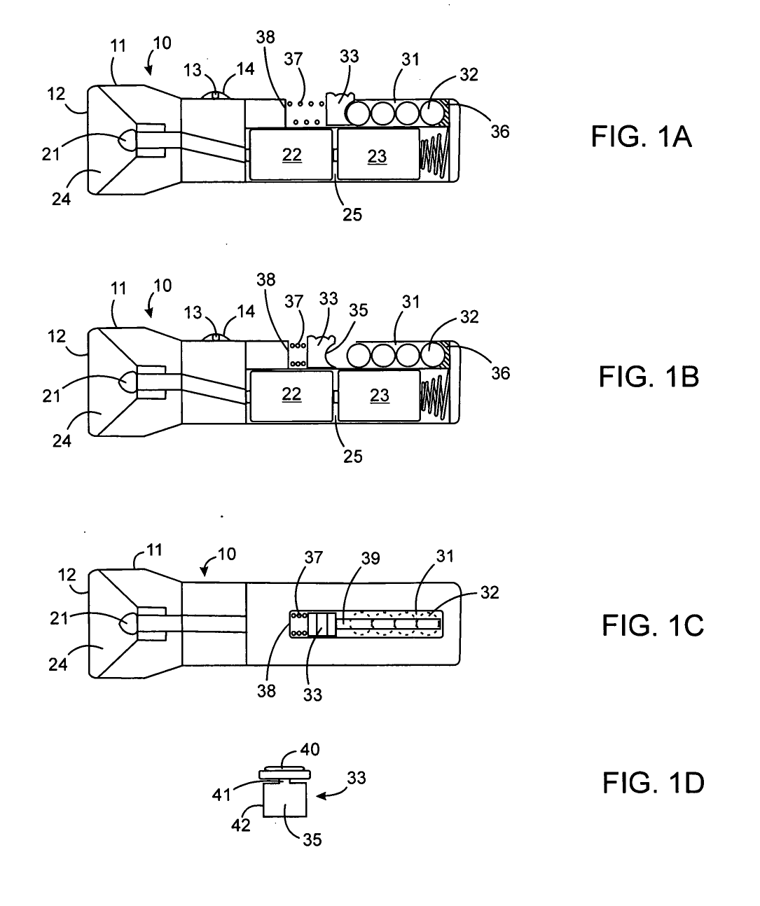

Referring to FIGS. 1A and 1B, a first embodiment of a dive accessory of the present invention is shown with a clacker in an off-position (FIG. 1A) and in an on-position (FIG. 1B). The dive accessory 10 comprises a shock resistant plastic outer shell 11 in which transparent front lens 12 permits illumination in front of the dive accessory from a light maker comprising LED 21 electrically connected to two D-cell batteries 22,23. LED 21 and batteries 22,23 are located in waterproof compartments 24,25, respectively. LED 21 is switched on and off using a depression switch 13 located under elastomeric membrane seal 14. The mechanical and electrical arrangement for the light maker is typical of the art, for example as described in U.S. Pat. Nos. 6,547,414, 4,114,187, 4,531,178 or 4,870,550, the disclosures of which are herein incorporated by reference.

The clacker comprises a hollow chamber 31 containing four spherical solid stainless steel ball bearings 32 (only one labeled) and a slide switch 33 for selectively restraining and selectively permitting movement of the bearings 32 in the hollow chamber 31. The slide switch has a curved surface 35 that matches the curvature of the bearings 32. The slide switch 33 is slidable within the hollow chamber between an object restraining position (i.e. the off-position) as shown in FIG. 1A and an object liberating position (i.e. the on-position) as shown in FIG. 1B. When the slide switch 33 is in the on-position, the bearings 32 are permitted to move in the hollow chamber 31 and a diver may shake the dive accessory so that the bearing 32 strike each other and end wall 36 of the hollow chamber to produce a noise. When the slide switch 33 is in the off-position, the bearings 32 are restrained from moving so they cannot make noise by striking each other and the end wall. The slide switch 33 may be conveniently handled by a finger or thumb.

The clacker may further comprise means for automatically returning the switch to the off-position. For example, in dive accessory 10, a spring 37 (e.g. a compression spring) between the switch 33 and end wall 38 of the hollow chamber 31 biases the switch towards the bearings 32. Pressure from a diver's finger is able to slide the switch 33 to the object liberating position against the bias of spring 37. Release of the pressure will cause the spring 37 to automatically slide the switch 33 to the object restraining position. Although the diver is not required to actively close the switch, he may still do so if desired. A locking mechanism (not shown) may be used to hold the switch 33 in the on-position.

Referring to FIG. 1C, a top schematic view of the dive accessory of FIG. 1B is shown. The hollow chamber 31 is provided with a slot 39 of sufficient width to permit the slide switch 33 to slide within the slot. The slot 39 is sufficiently narrow so that the bearings 32 do not escape from the hollow chamber 31. Since the slot 31 opens the hollow chamber 31 to water, the inside of the hollow chamber is waterproofed to prevent water from entering into the other compartments of the dive accessory. Alternatively or additionally, a membrane seal may be used over the slot and switch to keep water out of the hollow chamber.

As shown in FIG. 1D, the switch 33 comprises an upper body portion 40 attached to a lower body portion 42 by a neck 41. The neck 41 is narrow enough to be able to slide through the slot of the hollow chamber. The curved surface 35 on the lower body portion 42 is sufficiently large to make considerable contact with the bearings. When the neck 41 is engaged in the slot, the upper and lower body portions engage the upper and lower surfaces of the hollow chamber to hold the switch on the hollow chamber. The upper body portion 40 is provided with ridges (best seen in FIGS. 1A and 1B) to provide better grip on the switch.

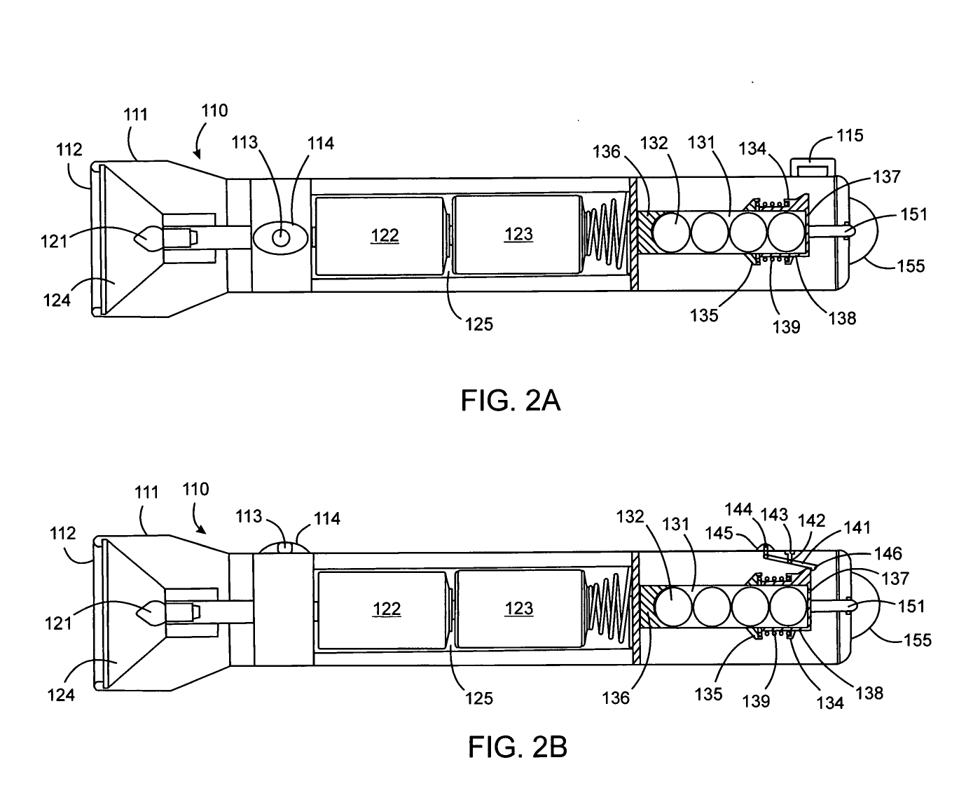

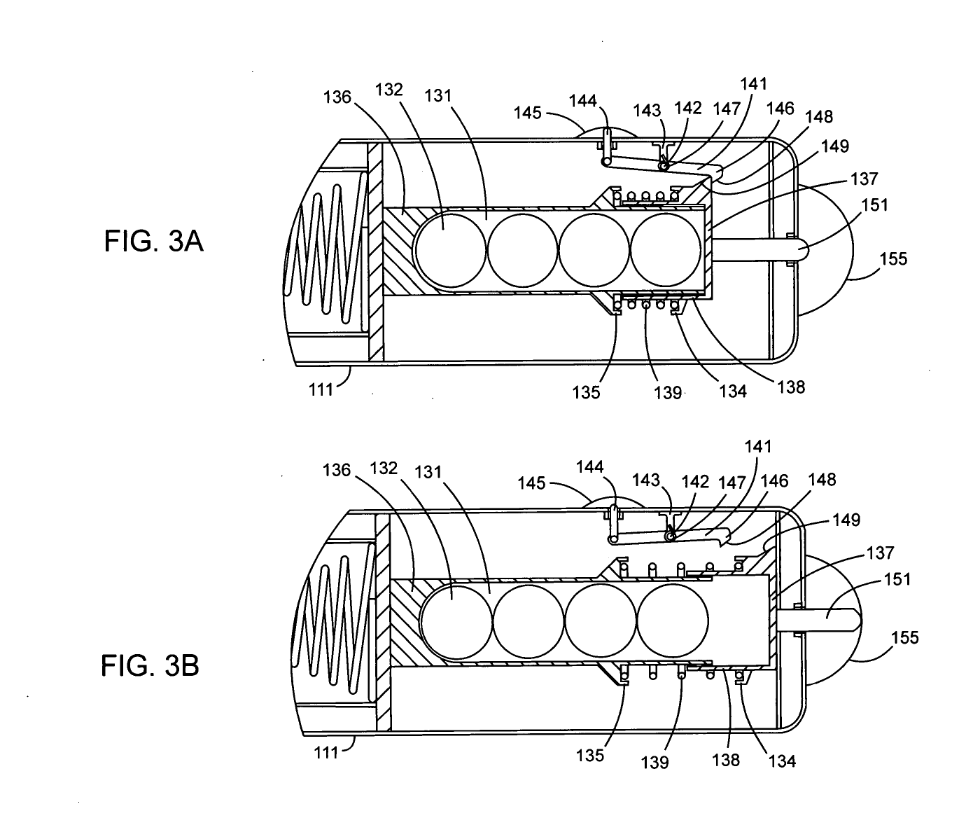

Referring to FIGS. 2A, 2B, 3A and 3B, a second embodiment of a dive accessory 110 of the present invention is depicted. FIGS. 2A and 2B show a clacker in an off-position. FIG. 3A is an enlarged view of the clacker depicted in FIGS. 2A and 2B, and FIG. 3B shows the clacker of FIG. 3A in an on-position. Dive accessory 110 comprises a shock resistant plastic outer shell 111 completely enclosing internal components. A D-ring 115 on the outer shell 111 may be used as an attachment point for a tether line (not shown) or other dive utility items.

Transparent front lens 112 permits illumination in front of the dive accessory from a light maker comprising LED 121 electrically connected to two D-cell batteries 122,123. LED 121 and batteries 122,123 are located in compartments 124,125, respectively. LED 121 is switched on and off using a depression switch 113 located under elastomeric membrane seal 114. The mechanical and electrical arrangement for the light maker is typical of the art, for example as described in U.S. Pat. Nos. 6,547,414, 4,114,187, 4,531,178 or 4,870,550, the disclosures of which are herein incorporated by reference.

The clacker comprises a cylindrical hollow chamber 131 containing four spherical solid stainless steel ball bearings 132 (only one labeled). The hollow chamber 131 comprises a fixed end wall 136 and a movable end wall 137. The movable end wall 137 is part of a thimble 138 that fits over and caps one end of the hollow chamber 131. As seen in comparing FIG. 3A to FIG. 3B, the movable end wall 137 is movable between a retracted position (FIG. 3A) and an extended position (FIG. 3B). When movable end wall 137 is in the retracted position (i.e. the off-position) the bearings 132 are restrained between the two end walls 136,137 so that the bearings are unable to move and unable to create noise. When movable end wall 137 is in the extended position (i.e. the on-position) the bearings 132 are permitted to move between the two end walls 136,137 so that, in response to the dive accessory being shaken, the bearings are able strike the end walls to create noise. A compression spring 139 biases the movable end wall 137 toward the extended position. The compression spring 139 is seated between lips 134,135 on the thimble 138 and the exterior of the hollow chamber 131, respectively.

Still referring to FIGS. 2A, 2B, 3A and 3B, it can be seen that means for selectively restraining movement of the bearings and means for selectively permitting movement of the bearings are different means having the movable end wall 137 as a common element.

The means for selectively permitting movement of the bearings comprises a depression switch having an armature 141 pivotally attached at a pivot point 142 to a pivot support 143. The pivot support 143 is attached to the inside of the outer shell 111. One end of the armature 141 is pivotally connected to an activation pin 144 under an elastomeric membrane seal 145. Another end of the armature 141 comprises a latch 146 that catches and holds the movable end wall 137 in the retracted position (FIG. 3A). Depression of the activation pin 144 causes the armature 141 to pivot at the pivot point 142 thereby lifting the latch 146 thereby disengaging the latch from the movable end wall. The movable end wall 137 is then free to move to the extended position (FIG. 3B), which it does automatically under the biasing influence of the compression spring 139. A torsion spring 147 located around the pivot point 142 automatically biases the latch 146 back into position for engaging the movable end when pressure is removed from the activation pin 144. The latch and the end wall have angled surfaces 148,149 respectively that permit the latch to snap back into engagement with the movable end wall 137 as the movable end wall is returned to the retracted position.

The means for selectively restraining movement of the bearings comprises a piston 151 attached to the movable end wall 137. Depression of the piston 151 when the movable end wall 137 is in the extended position (FIG. 3B) causes the movable end wall to move against the biasing effort of the compression spring 139 until the latch 146 engages the movable end wall in the retracted position holding the movable end wall in place (FIG. 3A). The piston 151 is located under an elastomeric membrane seal 155. A diver may apply sufficient pressure to the piston 151 to return the clacker to the off-position by applying the piston against an object, for example a rock, the diver's leg, the diver's palm, etc.

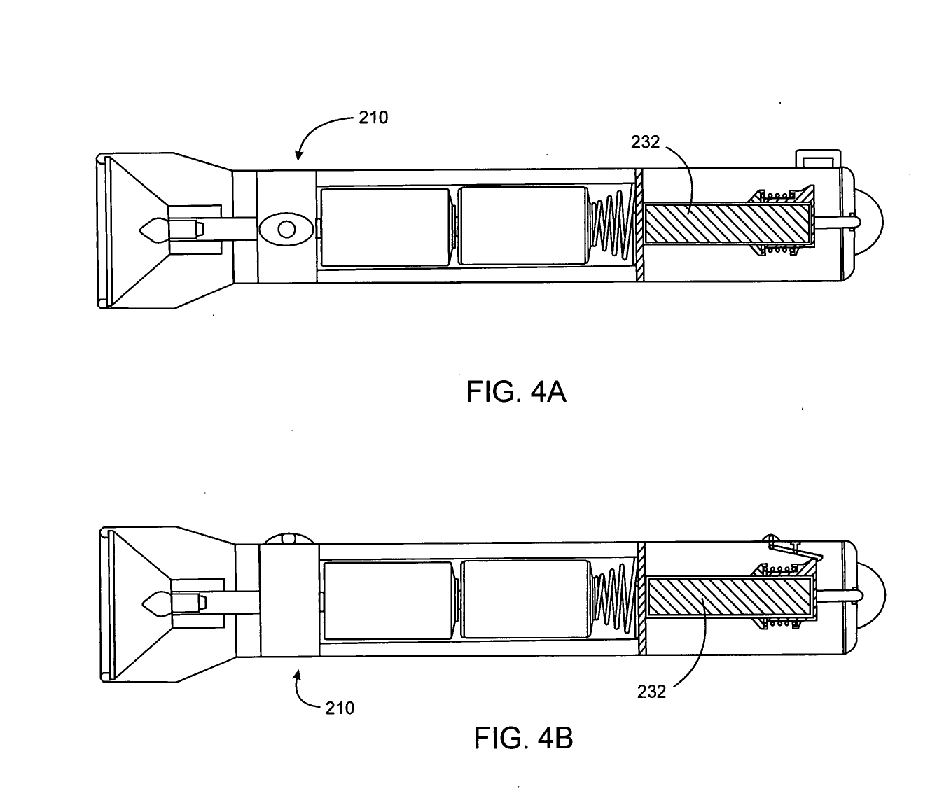

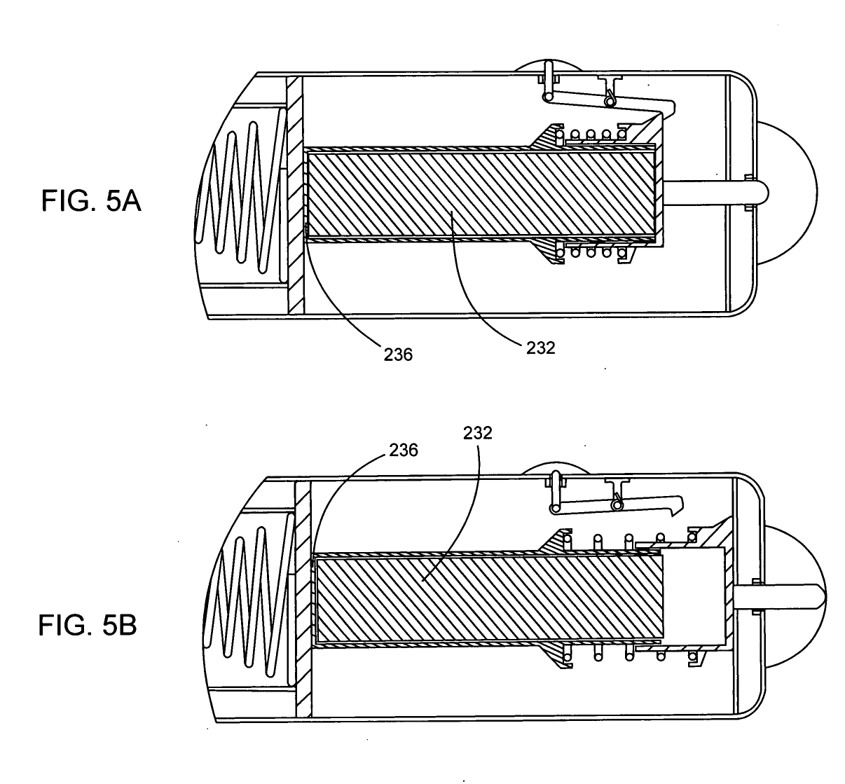

Referring to FIGS. 4A, 4B, 5A and 5B, a third embodiment of a dive accessory 210 of the present invention is depicted. The dive accessory 210 is similar to the dive accessory 110 previously described. However, dive accessory 210 comprises a single solid stainless steel cylinder 232 instead of four spherical solid stainless steel ball bearings. Since a cylinder is being used instead of spheres, fixed end wall 236 is flat instead of concave. Otherwise, the embodiment depicted in FIGS. 4A, 4B, 5A and 5B is constructed and works the same as the embodiment of FIGS. 2A, 2B, 3A and 3B.

Other advantages which are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A dive accessory comprising an outer shell encompassing a light maker and a noise maker,
the light maker being waterproofed and comprising a light source electrically connected to an electrical power source for powering the light source, and a light switch for selectively opening and closing the electrical connection between the light source and the electrical power source to switch the light source between an on state and an off state,
the noise maker comprising a hollow chamber having a solid object therein, the solid object movable within the hollow chamber to produce a noise when the solid object strikes a wall of the hollow chamber, the noise maker further comprising means for selectively restraining movement of the solid object to prevent the solid object from making noise and further comprising means for selectively permitting movement of the solid object to permit the solid object to make noise.

2. The dive accessory of claim 1, wherein the means for selectively restraining movement of the solid object and the means for selectively permitting movement of the solid object comprise a common element.

3. The dive accessory of claim 2, wherein the common element comprises a movable wall within the hollow chamber.

4. The dive accessory of claim 1, wherein the means for selectively restraining movement of the solid object and the means for selectively permitting movement of the solid object comprise the same means.

5. The dive accessory of claim 4, wherein the means for selectively restraining and permitting movement of the solid object comprises a slide switch slidable within the hollow chamber between an object restraining position and an object liberating position.

6. The dive accessory of claim 5, wherein the slide switch further comprises means for automatically returning the switch to the object restraining position.

7. The dive accessory of claim 6, wherein the means for automatically returning the switch comprises a spring.

8. The dive accessory of claim 1, wherein the means for selectively restraining movement of the solid object and the means for selectively permitting movement of the solid object are different means.

9. The dive accessory of claim 8, wherein the hollow chamber comprises a movable end, the movable end movable between a retracted position for restraining movement of the solid object and an extended position for permitting movement of the solid object.

10. The dive accessory of claim 9, wherein the means for selectively permitting movement of the solid object comprises an armature having means for engaging the movable end to hold the movable end in the retracted position and means for disengaging the armature from the movable end to permit the movable end to move to the extended position to permit movement of the solid object.

11. The dive accessory of claim 10, wherein the means for selectively permitting movement of the solid object further comprises means for biasing the armature into a position for engagement with the movable end.

12. The dive accessory of claim 11, wherein the armature has a first portion, a second portion and a pivot point between the first portion and the second portion, the means for engaging the movable end is on the first portion, the means for disengaging the armature from the movable end is on the second portion, and the means for biasing the armature comprises a torsion spring at the pivot point, whereby activation of the means for disengaging the armature causes the armature to pivot at the pivot point thereby disengaging the armature from the movable end, and whereby deactivation of the means for disengaging the armature permits the torsion spring to bias the armature into the position for engagement with the movable end.

13. The dive accessory of claim 9, wherein the means for selectively restraining movement of the solid object comprises a piston connected to the movable end, whereby depression of the piston causes the movable end to move to the retracted position to restrain movement of the solid object.

14. The dive accessory of claim 13, wherein the movable end in the retracted position engages the means for selectively permitting movement in order to prevent movement of the movable end to the extended position until and unless the means for selectively permitting movement of the solid object is activated.

15. The dive accessory of claim 14, wherein the means for selectively permitting movement comprises an armature having means for engaging the movable end to hold the movable end in the retracted position and means for disengaging the armature from the movable end to permit the movable end to move to the extended position to permit movement of the solid object.

16. The dive accessory of claim 15, wherein the means for selectively permitting movement further comprises means for biasing the armature into a position for engagement with the movable end.

17. The dive accessory of claim 16, further comprising biasing means for biasing the movable end toward the extended position.

18. The dive accessory of claim 1 further comprising an attachment ring, a tether line, a measuring device, a whistle, an audible electronic alarm, a dive computer, a GPS, a locator chip, a utility knife, a line cutter or a combination thereof.

19. A dive accessory comprising a waterproofed outer shell enclosing a light maker and a noise maker,
the light maker comprising a light source electrically connected to an electrical power source for powering the light source, and a switch for selectively opening and closing the electrical connection between the light source and the electrical power source to switch the light source between an on state and an off state,
the noise maker comprising a hollow chamber having a solid object therein, the solid object movable within the hollow chamber to produce a noise when the solid object strikes a wall of the hollow chamber, the hollow chamber comprising a movable end, the movable end movable between a retracted position for restraining movement of the solid object and an extended position for permitting movement of the solid object,
the noise maker further comprising a depression switch having an armature, means for biasing the armature into a position for engagement with the movable end to hold the movable end in the retracted position, and means for disengaging the armature from the movable end to permit the movable end to move to the extended position,
the noise maker further comprising a piston connected to the movable end, whereby depression of the piston causes the movable end to move to the retracted position where the armature engages the movable end to hold the movable end and restrain movement of the solid object,
the noise maker further comprising biasing means for biasing the movable end toward the extended position.

20. The dive accessory of claim 19, wherein the biasing means for biasing the movable end toward the extended position comprises a compression spring exterior to the hollow chamber, and wherein the armature has a first portion, a second portion and a pivot point between the first portion and the second portion, the means for engaging the movable end is on the first portion, the means for disengaging the armature from the movable end is on the second portion, and the means for biasing the armature comprises a torsion spring at the pivot point, whereby activation of the means for disengaging the armature causes the armature to pivot at the pivot point thereby disengaging the armature from the movable end, and whereby deactivation of the means for disengaging the armature permits the torsion spring to bias the armature into the position for engagement with the movable end.

21. The dive accessory of claim 20 further comprising an attachment ring, a tether line, a measuring device, a whistle, an audible electronic alarm, a dive computer, a GPS, a locator chip, a utility knife, a line cutter or a combination thereof.
